(19) United States
(12) Patent Application Publication
(10) Pub. No.: US 2014/0357315 A1
(43) Pub. Date: Dec. 4, 2014

(54) NEXT GENERATION SMART CARD

(71) Applicant: ALCATEL LUCENT, Paris (FR)

(72) Inventor: Rijin John, Bangalore (IN)

(73) Assignee: ALCATEL LUCENT, Boulogne Billancourt (FR)

(21) Appl. No.: 14/372,397

(22) PCT Filed: Dec. 18, 2012
(86) PCT No.: PCT/EP2012/075877

§ 371 Date: Jul. 15, 2014

(30) Foreign Application Priority Data
Jan. 16, 2012 (IN) 163/CHE/2012

(51) Int. Cl. H04W 8/18; H04W 12/04

(52) U.S. Cl. CPC H04W 8/183; H04W 12/04; H04W 88/06
USPC 455/552.1

(57) ABSTRACT

The embodiments herein relate to mobile technology and, more particularly, to use of smart cards in mobile technology. The embodiments herein disclose a smart card (201) that can be used in mobile devices (101) by which the mobile device will be able to utilize the resources of multiple mobile service providers (O1, O2, O3) simultaneously, hereby improving the user experience by better data throughput, service continuity, reliability and more.

### TECHNICAL FIELD

The embodiments herein relate to mobile technology and, more particularly, to use of Smart cards in mobile technology.

### BACKGROUND

The smart card is an integrated circuit that securely stores the International Mobile Subscriber Identity (IMSI) and the related key used to identify and authenticate users on mobile devices and may take the form of a Subscriber Identification Module (SIM) card, a FPGA, an IC or any other suitable form. Further, the smart card also contains its unique serial number (ICCID), internationally unique number of the mobile user (IMSI), security authentication and ciphering information, temporary information related to the local network, a list of the services the user has access to and two passwords: a personal identification number (PIN) for ordinary use and a personal unblocking code (PUK) for PIN unlocking The Smart card may be transferred between different mobile devices.

Currently, smart cards are capable of handling only one network operator at a time. In other words, if the user wants to access another network operator while in the coverage area of the network operator providing the smart card, then the user has to switch to a smart card belonging to the other network operator. Though, there are mobile devices which may use more than one smart card and keep multiple smart cards active simultaneously, it is still not possible to share multiple applications across the smart cards. There is no sharing or distribution of service among these smart cards of different network operators.

A multimode CSIM/USIM card for CDMA2000 and LTE networks has been introduced, which is able to handle authentication with current major network technologies. This card can either be used in a CDMA2000/LTE phone to access network operators using CDMA2000 and LTE or in an UMTS/LTE phone to access network operator using UMTS and LTE. When used in a multimode CDMA2000/UMTS/LTE phone, the card becomes a universal tool to access any available networks.

There also exists a SIM based roaming steering solution, which recognizes when a subscriber roams onto a foreign network operator and automatically downloads an updated preferred network operator list onto the SIM. A SIM applet can also be supplied which will cause the handset to read this new list immediately. The user can set roaming targets using a web based interface in precisely the same way as is used for the SS7 steering. This interface also provides feedback on the network operators which subscribers are actually connecting to.

Apple has introduced a technology called a Universal SIM, which would let iPhone users toggle between GSM networks without having to switch the so-called SIM cards that associate a phone with a network, according to one person.

However, none of the above mentioned solutions enable a user to share services from multiple network operators concurrently.

### SUMMARY

In view of the foregoing, an embodiment herein provides a smart card present in a mobile device, the smart card comprising of at least one means configured for enabling the mobile device to apportion the service among a selected plurality of network operators.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a mobile communication network, according to embodiments as disclosed herein;

FIG. 2 illustrates a smart card, according to embodiments as disclosed herein; and

FIGS. 3a and 3b depict an exemplary situation, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

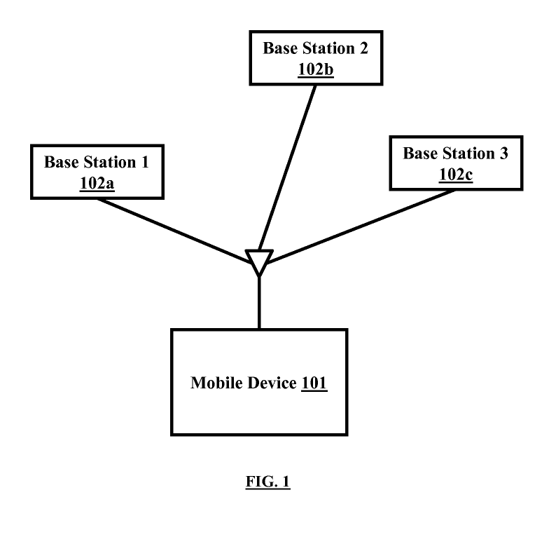

The embodiments herein disclose a smart card that can be used in mobile devices by which the mobile device will be able to utilize the resources of multiple mobile service providers simultaneously, hereby improving the user experience by better data throughput, service continuity, reliability and more. Referring now to the drawings, and more particularly to FIGS. 1 through 3, where similar reference characters denote corresponding features consistently throughout the figures, there are shown embodiments.

FIG. 1 illustrates a mobile communication network, according to embodiments as disclosed herein. The network, as depicted, comprises of a mobile device 101 connected to a plurality of Base Stations (BSs) 102a, 102b and 102c. The Base Stations (BSs) 102a, 102b and 102c may belong to different network operators. The mobile device 101 may be any device which uses a smart card for accessing network operator services. The mobile device 101 may comprise, but are not limited to, mobile phones, tablets, dongles, computers and so on.

The mobile device 101, on receiving a request for a service, from a user of the mobile device or from the network operator side, selects a plurality of the available network operators for providing the service. The network operators may be selected based on the preferences of the user, available signal strength received by the mobile device 101 from the network operators, mobility of the mobile device and so on. Mobility of the mobile device 101 refers to the degree of movement of the mobile device 101. Some mobile devices 101 may be stationary, say when the user is in his residence or office. For stationary mobile devices, the signal strengths of the network operators remain steady or vary within a very narrow range. Some mobile devices may be moving, say when the user is travelling in a car, a plane or walking For such mobile devices, the signal strength of the network operators varies largely across the time the user may take to avail the service. The mobile device 101 may also apportion the service among a plurality of network operators. The mobile device 101 may move the services to/from an already selected network operator to a different network operator in case of poor quality of service or loss of connectivity with the already selected network operator, thereby providing a better service continuity.

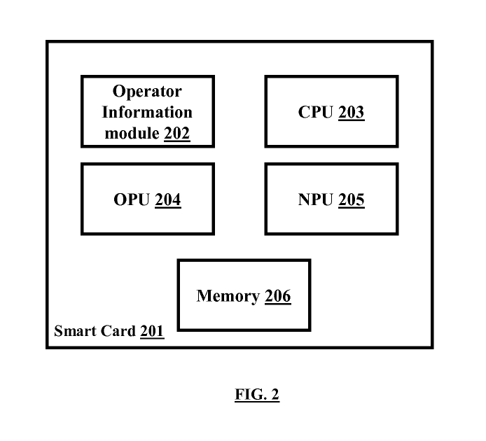

FIG. 2 illustrates a smart card, according to embodiments as disclosed herein. The smart card 201 enables the mobile device 201 to communicate with a mobile communication network. The smart card 201 may take the form of but is not limited to a SIM card, a FPGA based module, an Integrated circuit or any other single chip or an array of chips. The smart card 201, as depicted, comprises of an operator information module 202, a Central Processing Unit (CPU) 203, an Operator Processing Unit (OPU) 204, a Numeric Processing Unit (NPU) 205 and a memory 206.

The operator information module 202 is a configurable module where the information of all network operators to which the user of the mobile device 101 has subscribed will be accessible. The operator information module 202 offers an interface for a network operator to configure the smart card 201. The network operator may configure the smart card 201 by adding information related to the network operator, which will enable the user of the mobile device 101 to access services made available by the network operator. The network operator may also configure the smart card by removing information related to the network operator from the smart card 201. The operator information module 202 is configured to categorize and store information which is unique for each network operator in a separate section corresponding to each network operator within the memory 206. Such common information comprises of but is not limited to International Mobile Subscriber Identity (IMSI), Integrated Circuit Card Identifier (ICCID), Ki, LAI, IIN, SMSC, SPN, SDN, VAN, Emergency numbers, Network related parameters and so on. The operator information module 202 further categorizes and stores information which can be shared among multiple network operators within a common section within the memory 206. Such common information comprises of but is not limited to International Mobile Equipment Identity (IMEI), IP v6 and so on.

The CPU 203 supports and coordinates the functions of all modules present within the smart card 201 simultaneously. The CPU 203 may be a 32/64 bit processor. The CPU 203 may fetch information about specific network operators from the operator information module 202, on receiving an instruction from the mobile device 101. The CPU 203 further sends this information to the mobile device.

The OPU 204 handles the operations of handling multiple network operator access simultaneously. The OPU 204 functions as the master controller in all matters related to the simultaneous usage of different service provider resources. The OPU 204 may check the network operators that the current packets are destined for. The OPU 204 fetches the corresponding authentication key, Ki from the operator information module 202 and sends Ki to the mobile device 101 with the appropriate information about the network operator to which Ki belongs.

The NPU 205 handles all numeric related matters within the smart card 201 such as tasks related to the timer and so on.

The memory 206 stores network operator related information, information related to the mobile device 101 and so on. The memory 206 may also store information related to the user of the mobile device such as SMS related information, contact related information, applications present on the mobile device 101 and other related information.

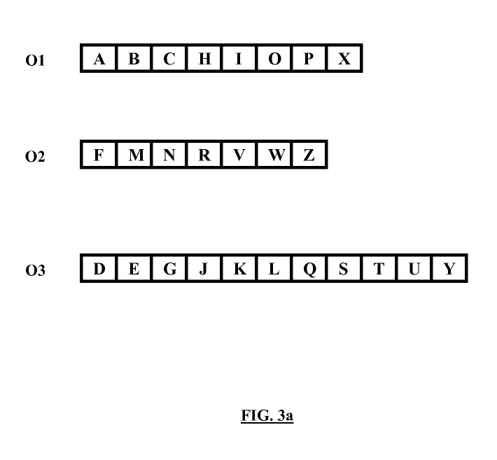

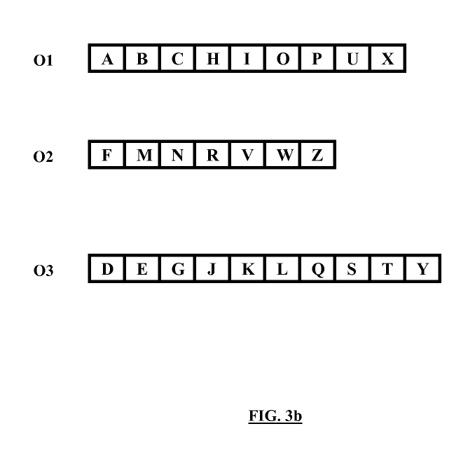

FIG. 3a depicts an exemplary situation, according to embodiments as disclosed herein. Consider the mobile device 101 having availability and authorized to access three network operators, O1, O2 and O3. If the user wants to download a file when the user is stationary, where the file comprises of a plurality of packets A, B, C, . . . , X, Y and Z. In the example herein, O3 has been assigned the highest preference score by the user, while O1 has the lowest preference score. While, the signal strength of O3 is greater than O1 and O2, the signal strength of O1 is greater than O2 presently. Based on the user preferences (where the user may have stated that he prefers having a good signal strength over the preference score assigned by him), the mobile device 201 apportions a larger portion of the packets to be downloaded to O3, while O1 gets apportioned more packets than O2 (due to the fact that the user has indicated that the network operator with better signal strength should get more packets, not considering the signal strength).

FIG. 3b depicts an exemplary situation, according to embodiments as disclosed herein. Consider the mobile device 101 having availability and authorized to access three network operators, O1, O2 and O3. If the user wants to download a file when the user is travelling in a car, where the file comprises of a plurality of packets A, B, C, , X, Y and Z. In the example herein, O3 has been assigned the highest preference score by the user, while O1 has the lowest preference score. While, the signal strength of O3 is presently greater than O1 and O2, the signal strength of O1 is greater than O2 presently. Based on the user preferences (where the user may have stated that he prefers having a good signal strength over the preference score assigned by him), the mobile device 101 apportions a larger portion of the packets to be downloaded to O3, while O1 gets apportioned more packets than O2 (due to the fact that the user has indicated that the network operator with better signal strength should get more packets, not considering the signal strength). After a specific duration of time, the mobile device 101 detects that the signal strength of O3 has dropped and O1 is having the best signal strength, the mobile device 101 may re-apportion the packets by reducing the number of packets assigned to O3 and increasing the packets assigned to O1.

Embodiments disclosed herein enable distribution of different services requests (live voice, download, streaming etc) to/from a mobile device between different network operators available in that location. By doing so, the effective data throughput for the end user will be the combined throughput of all the individual network operators that the mobile device uses.

Embodiments herein also enable movement of the services to/from a mobile device out of a certain network operator to a different network operator in case of poor quality of service or loss of connectivity with that particular network operator there by providing a better service continuity.

Embodiments herein enable utilization of bandwidth of different network operators more efficiency. Bandwidth sharing by different network operators can to a great extent compensate the bandwidth scarcity of the individual network operators. Sharing the resources will also lead to reduce the cost that otherwise was needed for network expansion of individual network operators.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

The embodiment disclosed herein specifies a smart card that can be used in mobile devices by which the mobile device will be able to utilize the resources of multiple mobile service providers simultaneously. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A smart card present in a mobile device, said smart card comprising of at least one means configured for enabling said mobile device to apportion said service among a selected plurality of network operators.

2. The smart card, as claimed in claim 1, wherein said smart card sends authentication key corresponding to each of said plurality of network operators to said mobile device.

3. The smart card, as claimed in claim 1, wherein said smart card is configured for storing information related to each of said plurality of network operators.

4. The smart card, as claimed in claim 1, wherein said smart card is adapted for being configurable by a plurality of network operators.
